(19) United States
(12) Patent Application Publication
(10) Pub. No.: US 2020/0263472 A1
(43) Pub. Date: Aug. 20, 2020

(54) PASSIVE CRUSH-PREVENTION DEVICE FOR DOORS

(71) Applicant: Daniel PRUJA, São Leopoldo (BR)

(72) Inventor: Daniel PRUJA, São Leopoldo (BR)

(21) Appl. No.: 16/651,989

(22) PCT Filed: Aug. 31, 2018
(86) PCT No.: PCT/BR2018/050311

§ 371 Date: Mar. 27, 2020

(30) Foreign Application Priority Data
Oct. 4, 2017 (BR) 10 2017 021345 5

(51) Int. Cl. E05F 5/04; E05C 17/00

(52) U.S. Cl. CPC E05F 5/04; E05F 2005/043; E05F 2005/046; E05C 17/00

(57) ABSTRACT

The present invention pertains to the technological sector of household items and refers, more specifically, to a passive safety device applied to doors in order to prevent them, when closing unexpectedly, from causing accidents to body parts of humans or animals. Since the safety devices applied for this purpose present the obstacle of being removed or disarmed when the user wishes to close the door (7), the present invention presents a passive combination (1) endowed with rod (2) and fastening element (4) that should be attached to the handle (5) present on the door (7) in such a way as to move together with it (5). This causes the rod (2) endowed or not with a stop (3) to stand between the door (7) and the frame (6) passively in order to prevent the unexpected closing of the door and preserve the security space (8) preventing body parts of people or animals from being crushed.

### TECHNOLOGICAL SECTOR OF THE INVENTION

In general, the present invention pertains to the technological sector of household items and refers, more specifically, to a passive safety device applied to doors in order to prevent them, when closing unexpectedly, from causing domestic accidents to body parts of humans or animals.

### KNOWN STATE OF THE ART

Recent studies indicate that 37% of all care provided to injured people in Brazilian hospitals comes from accidents occurring in domestic environments (http://preveniremcasa.com.br/os-numeros-de-acidentes-domesticos-no-brasil/—surveyed on Aug. 21, 2017). In this context, domestic accidents involving unexpected door closure are not uncommon.

Therefore, these incidents happen frequently and, especially when involving children, such accidents have much more severe effects, and may lead to hospitalization or even death. This is due to the fact that when undergoing the effect of winds circulating indoors, for example, doors acquire high accelerations due to the torque produced on their axis. Thus, since the doors, when opened, can suffer events caused by said air currents, it is evident that the impact of the object with its doorway can be the source of several domestic incidents with various severity scales.

For the most part, accidents in the home could be avoided by taking some preventive measures. Accidents caused by unexpected door closures are no different. Several preventive measures against this type of incident are currently available as objects that can be fitted onto doors in order to prevent the impact of the door on the doorway. Usually these safety objects are disposed on the doors, promoting a bulkhead that protects the hands and other body parts of humans and animals.

However, it is known that the technologies currently available on the market present flaws that end up hindering their use, such as the fact that they do not allow the doors to be closed without removing them. Put otherwise, among the security objects currently available on the market, the arrangement of fixed elements that prevent the undue closing of doors due to air currents is commonplace. Therefore, said technologies are installed in environments and require that the user withdraws it from the door and/or doorway when they wish to close it. Thus, in the event of forgetting to reinstall anti-door-crushing safety systems, users end up being subject to domestic accidents.

That said, there are also some alternatives that represent the current state of the art and that are described in patent documents. Some examples can be observed as in the case of the U.S. patent of invention N^{o}. US20100050377 “DOOR MOUNTED FINGER SAFETY DEVICE AND ITS METHOD OF USE”. This prior art presents a device capable of preventing the impact of the door with the doorway, in case of unexpected closing, through an articulated lever attached to the door leaf. However, despite arming itself automatically, during the opening of the door, this equipment does not allow the closing of the door on which it is installed until the user removes the combination.

There is also the Chinese patent N^{o}. CN2005001075 “SEMI-AUTOMATIC FINGER PROTECTION DEVICE FOR A DOOR” which discloses a semi-automatic finger protection device applicable to a door comprising a bumper (20) positioned between the outer surface of the door and the doorway, so that when the door unexpectedly closes, it runs into this device and does not reach the doorway. However, similar to the previous patent, this also prevents the door where it is installed from being closed. It has to be disarmed for the door to be closed.

Finally, Brazilian patent N^{o}. PI 0100329-1 A2 “FINGER BLOCKER FOR THE DOOR LEVER” discloses a device for the protection of human parts, especially children, against the lever formed between the door and the stop, composed of two plastic parts, one being a rigid and one malleable, which fit together preventing the shock of the door with the stop. However, this equipment was developed to protect the door hinge span and, therefore, is unrelated to the technical problems solved by the present invention.

With this, from all the inconveniences existing in the systems and equipment currently used and described above in the state of the art, there is a visible gap in the creation of a safety device applied to doors capable of avoiding the sudden closure of these objects. Moreover, it is clear that it is necessary to make available on the market a system that allows users to have a compact and easy-to-handle safety object in order to avoid crushing parts of the human body or animals.

### NOVELTIES AND OBJECTIVES OF THE INVENTION

Based on the problems already mentioned in the state of the art, the present invention is designed to provide the market with an efficient, practical and safe solution in the prevention of domestic accidents arising from the impact of doors in unexpected closing.

As already described, the current protection systems applied to doors present, among several drawbacks, the technical problem of not allowing the closing of doors without being uninstalled or disarmed. Therefore, these devices offer high risks for users who, when removing them in order to close the door, end up forgetting to reinstall them and, accordingly, are exposed to accident risks.

Thus, the present invention is composed of a set of elements that should be applied to the door handle, so that the set passively moves with the handle, which allows said system to perform the function of preventing the impact between the door and the doorway when the handle is not activated and allow the door to close when the handle is activated.

Finally, in order to remedy the shortcomings of the current state of the art highlighted above, the aim of this patent of invention patent is to propose a passive safety device applied to doors in order to prevent them, when closing unexpectedly, from crushing body parts of humans or animals.

### DESCRIPTION OF THE ACCOMPANYING DRAWINGS

In order for the present invention to be fully understood and put into practice by any technician in this technological sector, it will be described clearly, concisely and fully, based on the accompanying drawings, which illustrate and support it listed below:

FIG. 1 represents the device in question, showing its composition.

FIG. 2 represents the device applied to the inactivated handle of a closed door.

FIG. 3 represents the device applied to the activated handle of a closed door.

FIG. 4 represents the device applied to the inactivated handle of an open door.

FIG. 5 represents the device applied to the inactivated door handle of a half-open door during unexpected closing, showing that it is impossible for the door to bang against the doorway.

FIG. 6 represents a variant of the fastening element endowed with two screws.

FIG. 7 represents a variant of the fastening element endowed with four screws.

FIG. 8 represents a variant of the fastening element endowed with a pressure strap.

FIG. 9 represents a variant of the fastening element endowed with a blocking system.

FIG. 10 represents a variant of the fastening element endowed with locking belt.

FIG. 11 represents a variant of the fastening element endowed with toothed locking belt.

FIG. 12 represents a variant of the fastening element endowed with handle system by means of jacket with pressure.

FIG. 13 represents a variant of the fastening element endowed with a handle system by means of a jacket with pressure, applied to the handle.

FIG. 14 represents a variant of the fastening element endowed with handle system by means of jacket without pressure.

FIG. 15 represents a variant of the fastening element endowed with a handle system by means of a jacket without pressure, applied to the handle.

FIG. 16 represents a variant of the device in question applied to the handle endowed with articulated rod, with the door closed and handle not activated.

FIG. 17 represents a variant of the device in question applied to the handle endowed with articulated rod, with the door closed and handle activated.

FIG. 18 represents an exploded view of the articulation of the variant of the device in question, showing the articulation elements.

FIG. 19 represents a variant of the device in question consisting of a monolithic block, in which the stop and rod are joined.

### DETAILED DESCRIPTION OF THE INVENTION

In order for all the objectives proposed in the present invention to be put into practice by any person skilled in the art, it must be composed basically of a rod (2) formed by flexible and resistant material such as polymers. Moreover, the solution is arranged, and may be, alternatively, a rigid rod (2) and endowed with articulation (17); and a rod (2) endowed with a stop (3) consisting of a cushioning material, such as rubber.

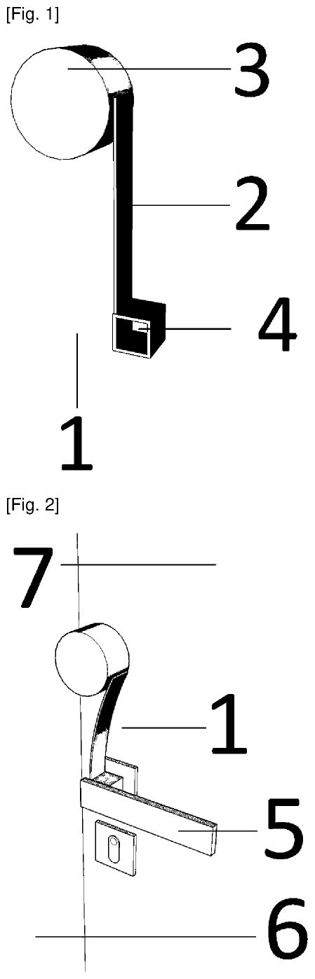

This set (1) must be attached to the door handle (5) of a door (7) by means of the fastening element (4) in order to move together with the handle (5). Therefore, once the handle (5) is not activated the assembly (1) remains in the vertical position as can be seen in FIGS. 2, 4 and 5. It is observed that due to the pressure exerted on the set (1), especially on the stop (3) and the rod (2), by the door frame (6), in FIG. 2, these elements (2) (3) appear slightly displaced.

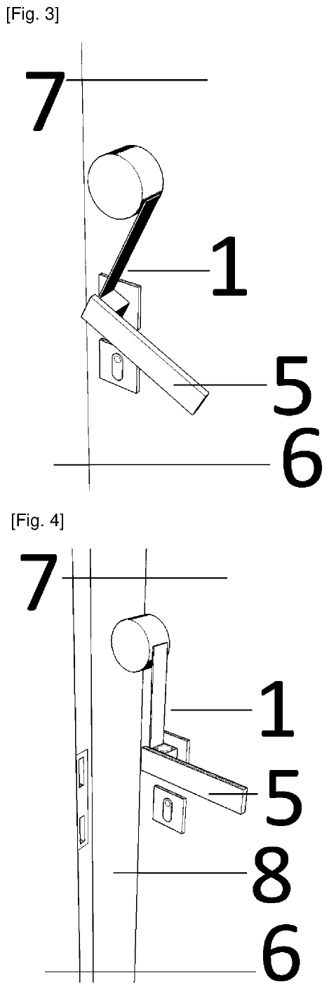

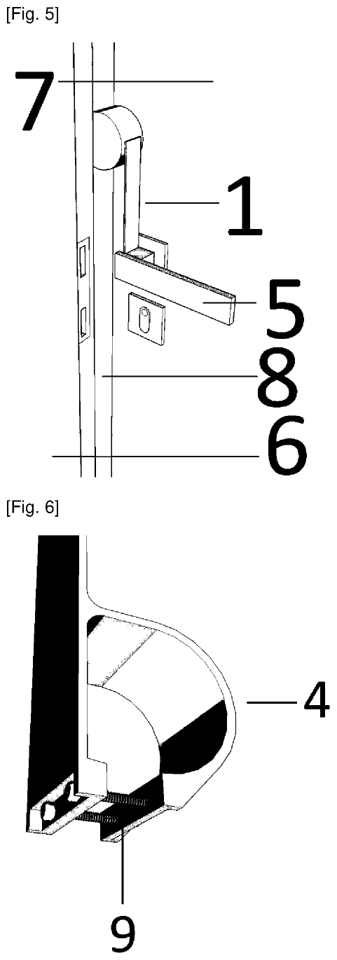

From then on, when the user wants to open or close the door (7), he/she must activate the handle (5), push it (7) and then release the handle (5) so that it (5) returns to the vertical position, as can be seen in FIGS. 2, 3, 4 and 5. Once this procedure is performed, the door (7) may remain open, since the rod (2) endowed or not with a stop (3), already in the vertical position, will be between the door (7) and the doorway (6) in the event of an unexpected closing of the door (7). Thus, the safety space (8) will be preserved by eliminating the risks of crushing, as shown in FIG. 5.

It is noteworthy that the fastening element (4) can have varied shapes and dimensions, as can be seen in the non-limiting examples represented in FIGS. 6 to 15, in order to adjust to the handles currently used. In these figures, the following fastening elements are observed: two-screw clamp (9), four-screw clamp (10), strap clamp (11), blocking (12), belt (13), toothed belt (14), jacket-type handle with pressure (15) and jacket type handle without pressure (16), which will be described in detail below.

In general, the exemplary solution proposed can be implemented through a rod (2) having a length that can vary from 5 to 20 cm, preferably 12 cm and a width that can range from 0.5 to 10 cm, preferably 2 cm when used with stop or with a superior portion with a width of 4 cm if the option of a monolithic block (rod and stop joined), and thickness can vary from 0.1 to 5 cm depending on the density of the material. In addition, when using a stop, it is important that it is sized with dimensions defined according to the size of the safety space (8) that is desired, ranging from 3 to 10 cm, preferably 4 cm, and a fastening element (4) consisting of rigid material, such as rigid polymer, arranged so that the lower end of the rod (2) is attached to the upper portion of the fastening element (4) and the upper end of the rod (2) is fixed to the stop (3).

### Example 1

This example presents the fastening element (4) whose variant has two screws (9) laterally arranged at the bottom of the element (4) which are tightened in order to attach the device (1) to the handle (5), as shown in FIG. 6. This example can be applied to the device in the variants of rigid rod (2), articulated rod (2) or monolithic device (22).

### Example 2

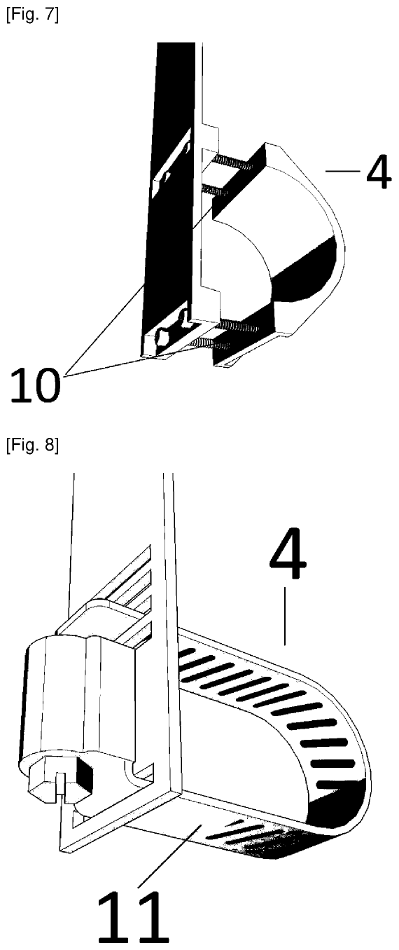

This example shows the fastening element (4) whose variant has four screws (10) arranged two by two laterally at the bottom and top of the element (4) which are tightened in order to attach the device (1) to the handle (5), as observed in FIG. 7. This example can be applied to the device in the variants of rigid rod (2), articulated rod (2) or monolithic device (22).

### Example 3

This example presents the fastening element (4) whose variant has at least one pressure strap (11) with a twisting element and slits present in the strap and rod (2), in which the strap is inserted into the slots and the twisting element, which must be tightened in order to attach the device (1) to the handle (5), as shown in FIG. 8. This example can be applied to the device in the variants of rigid rod (2), articulated rod (2) or monolithic device (22).

### Example 4

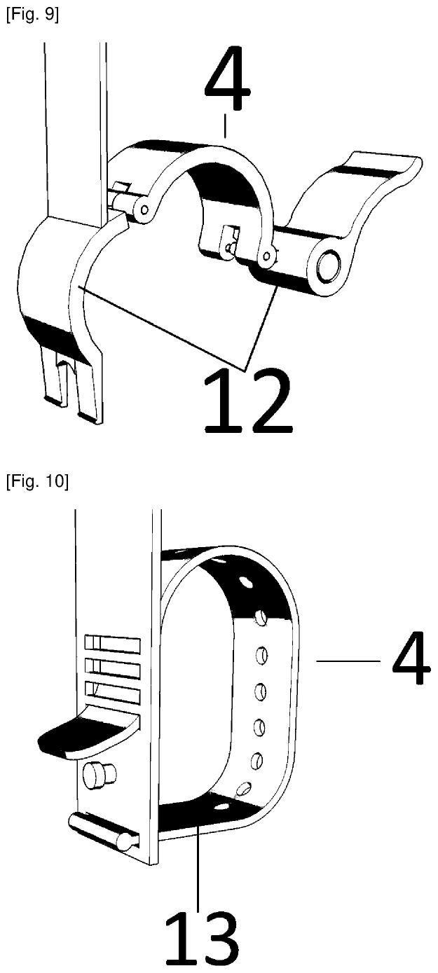

This example presents the fastening element (4) whose variant has a blocking system (12) with a fastening element by encasement, endowed with an articulated fastening pin with male element and input with female element, which should receive the male element that should be pressed in such a way that it is parallel to the rod (2) in order to attach the device (1) to the handle (5) as shown in FIG. 9. Such an example can be applied to the device in the variants of rigid rod (2), articulated rod (2) or monolithic device (22).

### Example 5

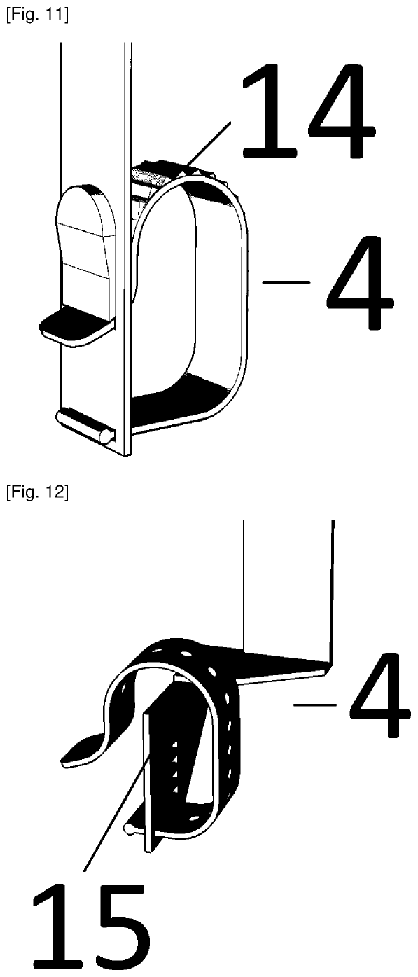

This example shows the fastening element (4) whose variant has a locking belt system (13) with fastening pin and holes present in the strap and rod (2) so that the belt should go through the rod holes (2) and the belt holes should be passed through the fastening pin in order to attach the device (1) to the handle (5), as shown in FIG. 10. This example can be applied to the device in the variants of rigid rod (2), articulated rod (2) or monolithic device (22).

### Example 6

This example shows the fastening element (4) whose variant has a toothed locking belt system (14) which should pass through at least one slit present in the rod (2) such that the belt should be pulled in order to attach the device (1) to the handle (5), as shown in FIG. 11. Such an example can be applied to the device in the variants of rigid rod (2), articulated rod (2) or monolithic device (22).

### Example 7

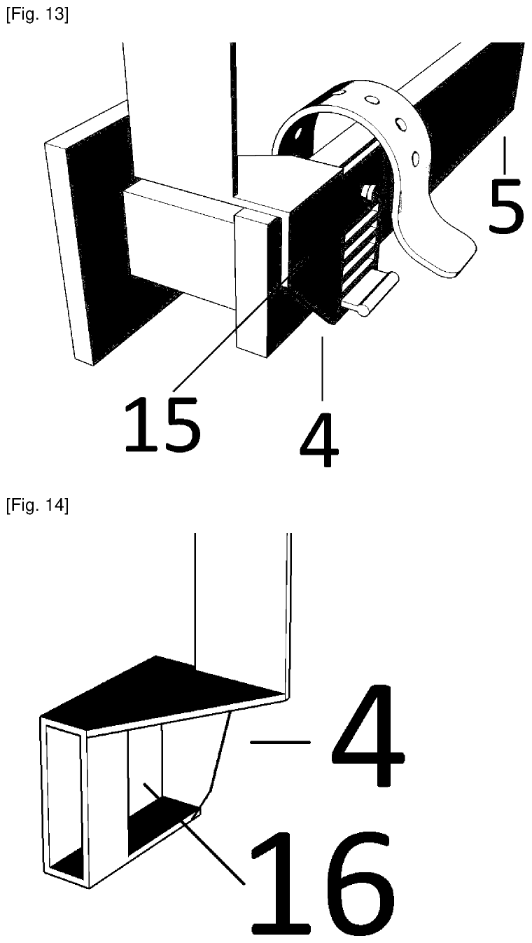

This example presents the fastening element (4) whose variant has a jacket-ended handle system (15) with pressure fastening pin and holes present in the strap such that the belt holes should be pierced by the fixing pin in order to fix the device (1) to the handle (5), as shown in FIGS. 12 and 13. This example can be applied to the device in the variants of rigid rod (2), articulated rod (2) or monolithic device (22).

### Example 8

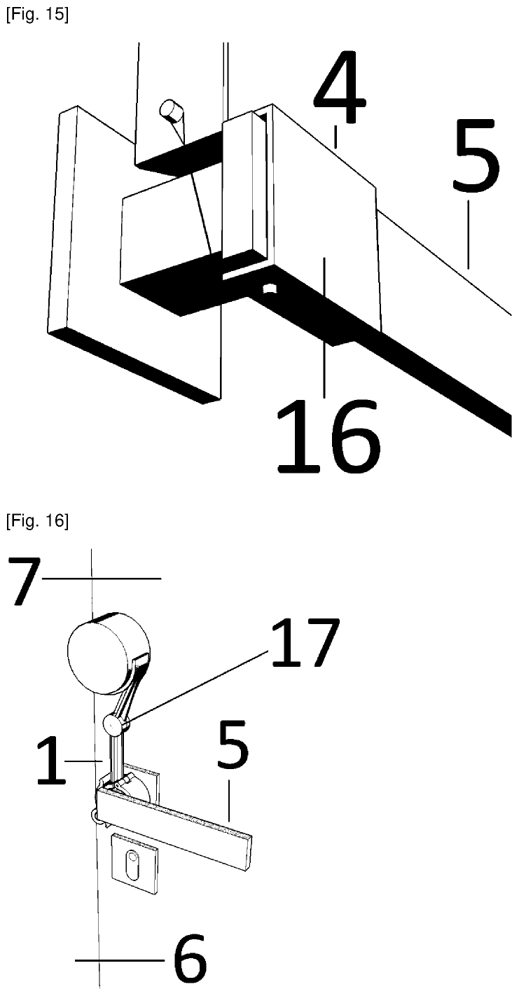

This example presents the fastening element (4) whose variant has a handle system endowed with jacket (16) with a fitting element in the shape of the handle without pressure, endowed with two pins on which a locking element is fixed, preferably an elastic in order to attach the device (1) to the handle (5), as shown in FIGS. 14 and 15. This example can be applied to the device in the variants of rigid rod (2), articulated rod (2) or monolithic device (22).

Such examples are designed to elucidate the application of different fastening techniques already known or not, but without limiting the present invention to them, so that any other types of fastening already known or that may be developed in the future can be used for this purpose.

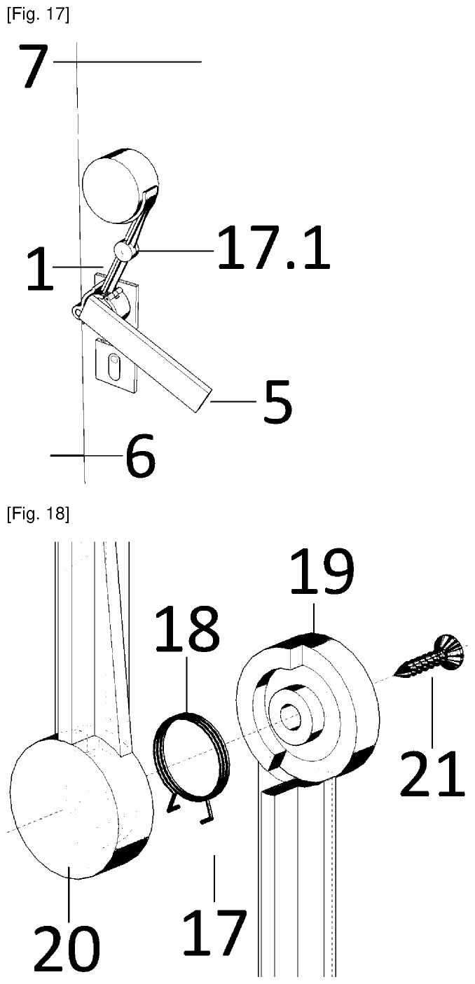

In order to describe in detail the arrangement in which the rod (2) is rigid and endowed with articulation, as can be seen in FIGS. 16, 17 and 18, this variant presents an arrangement that avoids the wear of the rod (2) due to continuous effort. Therefore, FIG. 16 presents the rod (2) endowed with articulation (17) at the moment when the door is closed and, therefore, flexed (17). FIG. 17 represents the rod (2) with the door open and, therefore, not flexed (17.1). More specifically, FIG. 18 represents one of the possible models of articulation (17), making use of at least one spring (18) involved by the ends (19) (20), which have a specific shape to encase and allow the rotation movement being fixed by a fastening element (21).

It should be noted that the materials used in the development of this device may vary freely, not limiting the concepts disclosed herein, since certain types of materials can be chosen with the intention of favoring certain features of the equipment for various applications.

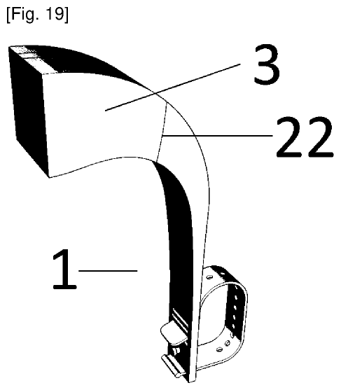

Finally, this specification presents the device now disclosed (1) with the stop (3) and the rod (2) forming a single element (22), as shown in FIG. 19. This variant exemplifies a plurality of formatting that the set (22) or the stop (3), in isolation, can assume, such as the exposed form, the form of animals, musical instruments, means of transport, or any other, which does not limit the present inventive concept at all.

It is important to point out that the drawings and descriptions do not have the weight of limiting the forms of execution of the inventive concept proposed herein, but rather to illustrate and make understandable the conceptual innovations disclosed in this solution. Thus, the descriptions and images should be interpreted in an illustrative and non-limiting way, and there may be other equivalent or analogous forms of implementation of the inventive concept now disclosed and that do not stray from the scope of protection outlined in the proposed solution.

This specification is of an easy-to-manufacture safety device applied to doors in order to prevent them, when unexpectedly closing, from crushing body parts of human beings or animals, endowed with novelty, activity inventive, full disclosure, industrial application and, consequently, satisfying all the essential requirements for the privilege claimed to be granted.

1. A PASSIVE ANTI-CRUSHING DEVICE FOR DOORS comprising at least one rod (2) allocated in doors characterized by being composed of a flexible or rigid (2) rod allocated through fastening elements on the handle (5) of doors and connected directly to the axis of the handles; said rod is endowed with at least one stop (3) arranged at its distal end; in which said set (1) is activated passively through the opening and closing of the door when the handle (5) is activated by the user.

2. The PASSIVE ANTI-CRUSHING DEVICE FOR DOORS according to claim 1, and further characterized by comprising a rod (2) endowed with articulation (17) in its intermediate portion.

3. The PASSIVE ANTI-CRUSHING DEVICE FOR DOORS according to claim 1, and further characterized in that said rod (2) presents a length that can vary from 5 to 20 cm, preferably 12 cm, a width ranging from 0.5 to 10 cm when used with stop, preferably 2 cm, and a thickness that can range from 0.1 to 5 cm.

4. The PASSIVE ANTI-CRUSHING DEVICE FOR DOORS according to claim 1, and further characterized in that said rod (2) presents a length that can vary from 5 to 20 cm, a width ranging from 0.5 to 10 cm when used with stop or with upper portion with 4 cm width if monolithic block option and a thickness that can vary from 0.1 to 5 cm.

5. The PASSIVE ANTI-CRUSHING DEVICE FOR DOORS according to claim 1, and further characterized in that said stop (3) has thickness dimensions that can vary from 3 to 10 cm, preferably 4 cm.

6. The PASSIVE ANTI-CRUSHING DEVICE FOR DOORS, according to claim 1 and further characterized in that the stop (3) is injected together with the rod (2) consisting of a single element (22) with the rod (2).

7. The PASSIVE ANTI-CRUSHING DEVICE FOR DOORS according to claim 1, and further characterized by being installed on the handle (5) of the door (6) by way of two screws (9) laterally arranged at the bottom of the element (4).

8. The PASSIVE ANTI-CRUSHING DEVICE FOR DOORS according to claim 1, and further characterized by being installed on the handle (5) of the door (6) by way of four screws (9) laterally arranged at the bottom of the element (4).

9. The PASSIVE ANTI-CRUSHING DEVICE FOR DOORS according to claim 1, and further characterized by being installed on the handle (5) of the door (6) by at least one pressure strap (11) with fastening element by means of twist and slits present on the strap and on the rod (2).

10. The PASSIVE ANTI-CRUSHING DEVICE FOR DOORS according to claim 1, and further characterized by being installed on the handle (5) of the door (6) by way of a blocking system (12) with fastening element by encasement, endowed with an articulated fixing pin with male element and input with female element.

11. The PASSIVE ANTI-CRUSHING DEVICE FOR DOORS according to claim 1, and further characterized by being installed on the handle (5) of the door (6) by way of a locking belt (13) with fixing pin and holes present in the strap and rod (2).

12. The PASSIVE ANTI-CRUSHING DEVICE FOR DOORS according to claim 1, and further characterized by being installed on the handle (5) of the door (6) by way of a toothed locking belt (14).

13. The PASSIVE ANTI-CRUSHING DEVICE FOR DOORS according to claim 1, and further characterized by being installed on the handle (5) of the door (6) through a handle system endowed with jacket (15) with fixing pin by pressure and holes present in the strap.

14. The PASSIVE ANTI-CRUSHING DEVICE FOR DOORS according to claim 1, and further characterized by being installed on the handle (5) of the door (6) through a handle system endowed with jacket (16) with fitting element in the shape of the handle (5), endowed with at least two pins, in which on both pins a locking element is fixed.
